(19) United States
(12) Patent Application Publication
(10) Pub. No.: US 2013/0191879 A1
(43) Pub. Date: Jul. 25, 2013

(54) METHODS AND SYSTEMS FOR INFORMATION ASSURANCE AND SUPPLY CHAIN SECURITY

(71) Applicants: Muhammed Jaber, Austin, TX (US); Mukund Purshottam Khatri, Austin, TX (US); Richard Holmberg, Austin, TX (US)

(72) Inventors: Muhammed Jaber, Austin, TX (US); Mukund Purshottam Khatri, Austin, TX (US); Richard Holmberg, Austin, TX (US)

(73) Assignee: DELL PRODUCTS L.P., Round Rock, TX (US)

(21) Appl. No.: 13/355,788

(22) Filed: Jan. 23, 2012

(51) Int. Cl. G06F 21/00

(52) U.S. Cl. 726/1; 726/28

(57) ABSTRACT

In accordance with additional embodiments of the present disclosure, a method may include storing information regarding one or more components of the information handling system to a database, the database stored on a basic input/output system (BIOS) of the information handling system prior to shipment of an information handling system. The method may also include, between the time of shipment of the information handling system to receipt of the information handling system by an intended customer of the information handling system: logging events associated with one or more components of the information handling system, and storing information associated with the events in the database. The method may further include interfacing with an authorized user of the information associated with the events to allow the authorized user to access the information associated with the events.

### TECHNICAL FIELD

The present disclosure relates in general to information handling systems, and more particularly to information assurance and supply chain security in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Increasingly, customers of information handling systems are demanding that vendors of information handling systems attest that information handling systems and their components be free of malicious code upon delivery and not be subject to introduction of malicious code in the supply chain of individual information handling systems.

### SUMMARY

In accordance with the teachings of the present disclosure, the disadvantages and problems associated with information assurance and supply chain security in an information handling system have been reduced or eliminated.

In accordance with embodiments of the present disclosure, an information handling system may include a processor and a basic input/output system (BIOS). The BIOS may have stored thereon a database comprising information regarding one or more components of the information handling system, including one or more policies associated with the one or more components and a security agent embodied as one or more instructions on the BIOS. The security agent may be configured to, when read and executed by the processor interface with an authorized user of the security agent to allow the authorized user to access the information regarding the one or more components, log events associated with the one or more components and store information associated with the events in the database, and control execution of the one or more components in accordance with the one or more policies.

In accordance with additional embodiments of the present disclosure, a method may include storing information regarding one or more components of the information handling system to a database, the database stored on a basic input/output system (BIOS) of the information handling system prior to shipment of an information handling system. The method may also include, between the time of shipment of the information handling system to receipt of the information handling system by an intended customer of the information handling system: logging events associated with one or more components of the information handling system, and storing information associated with the events in the database. The method may further include interfacing with an authorized user of the information associated with the events to allow the authorized user to access the information associated with the events.

In accordance with further embodiments of the present disclosure, an article of manufacture may include a computer readable medium and computer-executable instructions carried on the computer readable medium. The instructions may be readable by a processor, and, when read and executed, may cause the processor to: (i) prior to shipment of an information handling system, store information regarding one or more components of the information handling system to a database, the database stored on a basic input/output system (BIOS) of the information handling system; and (ii) between the time of shipment of the information handling system to receipt of the information handling system by an intended customer of the information handling system: log events associated with one or more components of the information handling system, and store information associated with the events in the database; and (iii) interface with an authorized user of the information associated with the events to allow the authorized user to access the information associated with the events.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure; and

FIG. 2 illustrates a flow chart of an example method for information assurance and supply chain security in an information handling system, in accordance with certain embodiments of the present disclosure.

### DETAILED DESCRIPTION

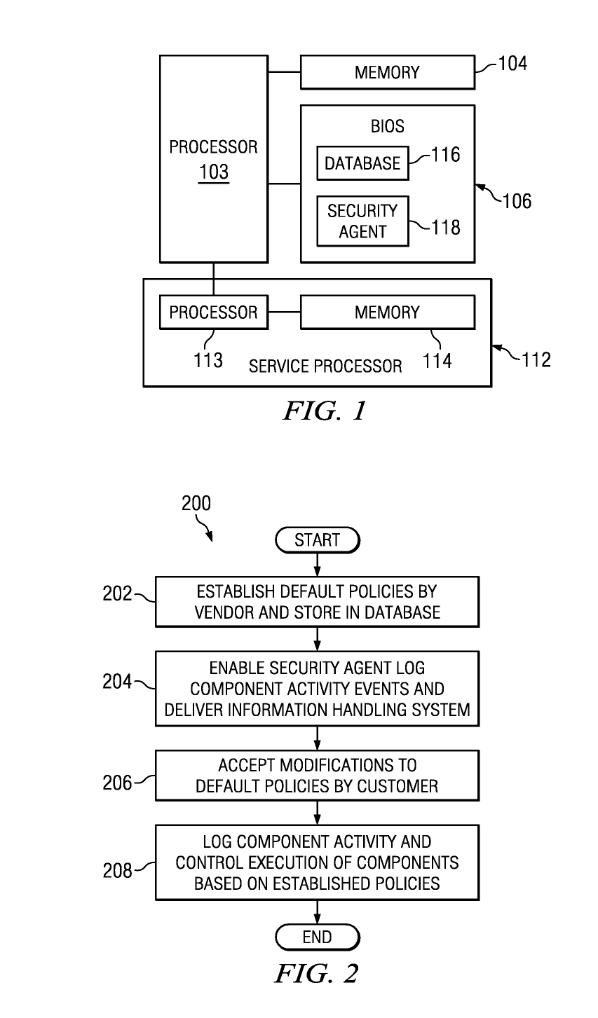

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), busses, memories, input-output devices and/or interfaces, storage resources, network interfaces, motherboards, and/or any other components and/or elements of an information handling system.

FIG. 1 illustrates a block diagram of an example information handling system 100, in accordance with certain embodiments of the present disclosure. In certain embodiments, information handling system 100 may be a server. In another embodiment, information handling system 100 may be a personal computer (e.g., a desktop computer or a portable computer). As depicted in FIG. 1, information handling system 100 may include a processor 103, a memory 104 communicatively coupled to processor 103, basic input/output system (BIOS) 106 communicatively coupled to processor 103, and a service processor 112 coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 106 and/or another component of information handling system 100.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 100 is turned off.

BIOS 106 may be communicatively coupled to processor 103 and may include any system, device, or apparatus configured to identify, test, and/or initialize information handling resources of information handling system 100. “BIOS” may broadly refer to any system, device, or apparatus configured to perform such functionality, including without limitation, a Unified Extensible Firmware Interface (UEFI). In some embodiments, BIOS 106 may be implemented as a program of instructions that may be read by and executed on processor 103 to carry out the functionality of BIOS 106. In these and other embodiments, BIOS 106 may comprise boot firmware configured to be the first code executed by processor 103 when information handling system 100 is booted and/or powered on. As part of its initialization functionality, BIOS code may be configured to set components of information handling system 100 into a known state, so that one or more applications 110 (e.g., an operating system or other application programs) stored on compatible media (e.g., memory 104) may be executed by processor 103 and given control of information handling system 100.

As depicted in FIG. 1, BIOS 106 may have stored thereon a security agent 116 and a database 118. Security agent 116 may include any system, device, or apparatus configured to manage security of components of information handling system, as further described in this disclosure. In some embodiments, security agent 116 may be implemented as a program of instructions that may be read from BIOS 106 by processor 103 and executed by processor 103 to carry out the functionality of security agent 116.

Database 118 may include any file, table, list, map, and/or other data structure having stored thereon information regarding trusted components of information handling system 100, policies regarding components of information handling system 100, identity information regarding components of information handling system 100 (e.g., hash values, digital signatures, etc.), measurements regarding components of information handling system 100, and/or other information. As used herein, the term “component” may refer to an information handling resource and/or a driver and/or application associated with such information handling resource. Information stored in database 118 may be protected from access by unauthorized users in any appropriate manner (e.g., password protected such that only privileged users and/or authorized applications may access such information).

Service processor 112 may be communicatively coupled to processor 103 and may include any system, device, or apparatus configured to permit an administrator or other person to remotely monitor and/or remotely manage information handling system 100 (e.g., via an information handling system remotely connected to information handling system 100 via a network) regardless of whether information handling system 100 is powered on and/or has an operating system installed thereon. In certain embodiments, service processor 112 may allow for “out-of-band” control of information handling system 100, such that communications to and from service processor 112 are communicated via a management channel physically isolated from an “in band” communication channel for non-management traffic associated with information handling system 100. Thus, for example, if a failure occurs in information handling system 100 that prevents an administrator from remotely accessing information handling system 100 via its traditional network interface (e.g., operating system failure, power failure, etc.), the administrator may still be able to monitor and/or manage the information handling system 100 (e.g., to diagnose problems that may have caused failure) via service processor 112. In the same or alternative embodiments, service processor 112 may allow an administrator to remotely manage one or parameters associated with operation of information handling system 100 (e.g., power usage, processor allocation, memory allocation, security privileges, etc.). In certain embodiments, service processor 112 may include or may be an integral part of an access controller, baseboard management controller (BMC), Dell Remote Access Controller (DRAC) or an Integrated Dell Remote Access Controller (iDRAC). In these and other embodiments, service processor 112 may be communicatively coupled to processor 103 via a keyboard control-style (KCS) interface bus or another suitable communication bus.

As depicted in FIG. 1, service processor 112 may include a processor 113 and a memory 114 communicatively coupled to processor 113. Processor 113 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 100. In some embodiments, processor 113 may be similar to processor 103. In other embodiments, processor 113 may be configured specifically for operation with service processor 112.

Memory 114 may be communicatively coupled to processor 113 and may include any system, device, or apparatus configured to retain program instructions and/or data for a period of time (e.g., computer-readable media). Memory 114 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 100 is turned off. In certain embodiments, memory 114 may store firmware that includes executable instructions to govern operation of service processor 112.

In operation, a vendor may, upon manufacture of information handling system 100, install database 118 as a “baseline” to include all information regarding all approved components of information handling system, including information that such components are approved. In some embodiments, such information may be encrypted using a key (e.g., public key) provided by a customer to the vendor, which may be unencrypted by another key known to the customer (e.g., a private key that, together with a public key provided by the customer, form a public-private key pair) so that the customer may access such information. Upon receipt by the customer of the information handling system, the customer may choose to edit database 118 to view and/or edit policies and/or other information regarding components of information handling system 100. A customer may view and/or edit information in database 118 by interfacing with security agent 116 via BIOS 106 and/or service processor 112 and providing appropriate credentials (e.g., username and password) indicating that the customer is privileged to edit database 118.

Policies established by a vendor or customer may be any suitable policy regarding a component. For example, a default policy set by a vendor may be a policy to “load and report” whereby security agent 116 may allow all components to execute but log information regarding what has executed (e.g., component name, whether component is signed, which authority signed component, etc.), thus providing the customer information regarding components that have executed. As another example, a customer may edit database 118 to create a “blacklist” setting forth a specific list of components that the customer does not desire to execute, and security agent 116 may prevent such blacklisted components from executing.

As a further example, each enumerated component of information handling system 100 may have assigned to it its own component-specific policy. For instance, a component-specific policy may be to always trust a component. Alternatively or in addition, a policy may be set in which a component is trusted so long as no modification has been made to the component or its configuration during a specific time period (e.g., since initial provisioning of information handling system 100). Alternatively or in addition, a policy may provide that a component may be trusted as long as they it is signed by a specific authority (e.g., a specific vendor or specific certificate authority). Alternatively or in addition, a policy may provide that a component may be trusted as long as it is signed by a specific user (e.g., an administrator) of the customer.

During boot of information handling system or at any other time, security agent 116 may examine policies and apply them so as to perform logging in accordance with a policy and/or prevent execution of a particular component in accordance with a policy.

In addition, security agent 116 may perform secure auditing, by logging information regarding existence of and/or events associated components of information handling resources. Such logged information may be encrypted using a key (e.g., public key) provided by a customer to the vendor and stored on BIOS 106 and/or another component of information handling system, which may be unencrypted by another key known to the customer (e.g., a private key that, together with a public key provided by the customer, form a public-private key pair) so that the customer may access such logged information. In some embodiments, such logged information may be stored in database 118. A customer may analyze such logged information to be assured that only those components that the customer expected to be present are present on information handling system 100, thus ensuring supply chain security of information handling system 100. For example, logged information may include information regarding which components of information handling system 100 have executed, and the customer may compare such logged information to a list of customer-authorized components to determine if unauthorized components have executed.

FIG. 2 illustrates a flow chart of an example method 200 for information assurance and supply chain security in an information handling system, in accordance with certain embodiments of the present disclosure. According to one embodiment, method 200 may begin at step 202. As noted above, teachings of the present disclosure may be implemented in a variety of configurations of information handling system 100. As such, the preferred initialization point for method 200 and the order of the steps 202-208 comprising method 200 may depend on the implementation chosen.

At step 202, a vendor of information handling system 100 may establish one or more default policies with respect to components of information handling system 100, and store such policies to database 118.

At step 204, the vendor may enable security agent 116 to log events associated with components of information handling system 100 to database 118 and deliver information handling system 100 to a customer. Logging of such events may allow the customer to ensure supply chain security by analyzing the logged information to determine that no unauthorized components are present or executing on information handling system 100.

At step 206, after receipt of information handling system 100 by the customer, security agent 116 may interface with the customer via BIOS 106 and/or service processor 112 (e.g., in response to customer's provision of authentic credentials) to accept modifications to remove or modify the default policies established by the vendor and/or one or more other policies in addition to the default policies.

At step 208, security agent 116 may log component events and/or control execution of components of information handling system 100 based on the established policies, as described in greater detail above. After completion of step 208, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 100 or any other system operable to implement method 200. In certain embodiments, method 200 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor; and
a basic input/output system (BIOS) having stored thereon:
a database comprising information regarding one or more components of the information handling system, including one or more policies associated with the one or more components; and
a security agent embodied as one or more instructions on the BIOS and configured to, when read and executed by the processor:
interface with an authorized user of the security agent to allow the authorized user to access the information regarding the one or more components;
log events associated with the one or more components and store information associated with the events in the database; and
control execution of the one or more components in accordance with the one or more policies.

2. An information handling system according to claim 1, wherein allowing the authorized user to access the information comprises accepting one or modifications to the one or more policies from the authorized user.

3. An information handling system according to claim 1, the security agent configured to store information associated with the events by encrypting the information associated with the events.

4. An information handling system according to claim 3, the information associated with the events encrypted with a private key corresponding to a public key accessible to the authorized user.

5. An information handling system according to claim 1, further comprising a service processor communicatively coupled to the processor, and the security agent further configured to interface with the authorized user via the service processor.

6. An information handling system according to claim 1, the security agent configured to log events associated with the one or more components and store information associated with the events in the database between the time the information handling system is delivered from the vendor and the time the information handling system is received by the customer.

7. An information handling system according to claim 1, wherein the BIOS comprises a Unified Extensible Firmware Interface.

8. A method comprising:
prior to shipment of an information handling system, storing information regarding one or more components of the information handling system to a database, the database stored on a basic input/output system (BIOS) of the information handling system;
between the time of shipment of the information handling system to receipt of the information handling system by an intended customer of the information handling system:
logging events associated with one or more components of the information handling system; and
storing information associated with the events in the database; and
interfacing with an authorized user of the information associated with the events to allow the authorized user to access the information associated with the events.

9. A method according to claim 8, the information regarding the one or more components including one or more policies associated with the one or more components and the method further comprising interfacing with the authorized user to modify the one or more policies.

10. A method according to claim 9, further comprising logging events associated with the one or more events in accordance with the one or more policies.

11. A method according to claim 9, further comprising controlling execution of the one or more components in accordance with the one or more policies.

12. A method according to claim 8, wherein storing information associated with the events in the database comprises encrypting the information associated with the events.

13. A method according to claim 12, the information associated with the events encrypted with a private key corresponding to a public key accessible to the authorized user.

14. A method according to claim 8, wherein the BIOS comprises a Unified Extensible Firmware Interface.

15. An article of manufacture, comprising:
a computer readable medium; and
computer-executable instructions carried on the computer readable medium, the instructions readable by a processor, the instructions, when read and executed, for causing the processor to:
prior to shipment of an information handling system, store information regarding one or more components of the information handling system to a database, the database stored on a basic input/output system (BIOS) of the information handling system;
between the time of shipment of the information handling system to receipt of the information handling system by an intended customer of the information handling system:
log events associated with one or more components of the information handling system; and
store information associated with the events in the database; and
interface with an authorized user of the information associated with the events to allow the authorized user to access the information associated with the events.

16. An article of manufacture according to claim 15, the information regarding the one or more components including one or more policies associated with the one or more components and the instructions further for causing the processor to comprising interface with the authorized user to modify the one or more policies.

17. An article of manufacture according to claim 16, the instructions further for causing the processor to log events associated with the one or more events in accordance with the one or more policies.

18. An article of manufacture according to claim 16, the instructions further for causing the processor to control execution of the one or more components in accordance with the one or more policies.

19. An article of manufacture according to claim 15, wherein storing information associated with the events in the database comprises encrypting the information associated with the events with a private key corresponding to a public key accessible to the authorized user.

20. An article of manufacture according to claim 15, wherein the BIOS comprises a Unified Extensible Firmware Interface.
